(19) United States
(12) Patent Application Publication
(10) Pub. No.: US 2017/0072548 A1
(43) Pub. Date: Mar. 16, 2017

(54) Adapter Assembly for Use in Aligning Pipe Flanges

(71) Applicant: 1729655 Alberta Ltd., Edmonton (CA)

(72) Inventor: Quinn Bender, Edmonton (CA)

(21) Appl. No.: 15/258,381

(22) Filed: Sep. 7, 2016

Related U.S. Application Data
(60) Provisional application No. 62/218,280, filed on Sep. 14, 2015.

(51) Int. Cl. B25B 27/16; F16L 23/00

(52) U.S. Cl. CPC B25B 27/16; F16L 23/003

(57) ABSTRACT

An adapter assembly is used with a pipe alignment tool for aligning a pipe flange having circumferentially spaced bolt apertures therein with a mating annular surface locating circumferentially spaced threaded fasteners therein. The pipe alignment tool has a clamp member secured about the pipe flange and one or more supporting members mounted on the clamp member so as to protrude axially beyond the pipe flange towards the mating annular surface. The adapter assembly includes i) a mounting body arranged to be mounted to extend in a circumferential direction about at least some of the threaded fasteners of the mating annular surface and ii) a cylindrical supporting surface located externally on the mounting body and adapted to be engaged by the supporting members of the pipe alignment tool to allow for axial and rotational adjustments between the pipe flange and the mating annular surface.

This application claims the benefit under 35 U.S.C. 119(e) of U.S. provisional application Ser. No. 62/218,280, filed Sep. 14, 2015.

### FIELD OF THE INVENTION

The present invention relates to an adapter assembly to adapt a pipe aligning tool which aligns two pipe flanges such that the pipe alignment tool can instead be used for aligning a pipe flange having circumferentially spaced bolt apertures therein with a mating annular surface locating circumferentially spaced threaded fasteners therein. More particularly, the present invention relates to an adapter assembly arranged to be mounted in a circumferential direction about the threaded fasteners of the mating annular surface so as to define a generally cylindrical supporting surface that can be engaged by supporting members of the pipe alignment tool which are normally used for engaging a second pipe flange.

### BACKGROUND

When connecting various pipeline equipment, in some instances a pipe flange that includes circumferentially spaced apart bolt apertures of one component must be joined to a mating annular surface of another component that locates a plurality of circumferentially spaced apart threaded fasteners therein. The threaded fasteners must each be aligned with a respective bolt aperture followed by a nut secured to the threaded fastener to clamp the pipe flange to the mating annular face. In one example, a pipeline component, for example a blow out preventer (BOP) is provided with an annular mounting surface which lies in a plane perpendicular to a central axis thereof for mating against the corresponding surface at the outer end of the pipe flange which also lies perpendicularly to the central axis thereof. The annular mounting surface can be mated to the pipe flange at the end of a pipe section, or alternatively the pipe flange of an adjacent pipeline component such as a second blow out preventer (BOP).

As described in U.S. Pat. No. 8,850,679 and United States Patent Application Publication No. US2015/0000091 by Quinn Bender, a pipe alignment tool for aligning abutted ends of first and second pipe sections to be joined includes a clamp member adapted to be clamped circumferentially about the first pipe section and one or more supporting members mounted on the clamp member adapted to extend across a seam between the abutted ends of the first and second pipe sections to overlap the second pipe section. A bearing member is rotatably supported on each supporting member for rolling contact with the second pipe section to assist in positioning the second pipe section relative to the first pipe section. The pipe alignment tool relies on the annular edge of the second pipe flange for engagement by the supporting members such that the alignment tool is not well suited for use in alignment of a pipe flange with a mating annular surface locating circumferentially spaced apart threaded fasteners therein that lacks an annular flange.

### SUMMARY OF THE INVENTION

According to one aspect of the invention there is provided an adapter assembly for use with a pipe alignment tool for aligning a pipe flange having circumferentially spaced bolt apertures therein with a mating annular surface locating circumferentially spaced threaded fasteners therein, the pipe alignment tool having a clamp member adapted to be clamped circumferentially about the pipe flange and at least one supporting member mounted on the clamp member so as to extend longitudinally from a first end fixed to the clamp member to an opposing second end protruding axially beyond the pipe flange, the adapter assembly comprising:

a mounting body arranged to be mounted in a circumferential direction about at least some of the threaded fasteners of the mating annular surface; and

a supporting surface located externally on the mounting body forming at least a portion of a cylinder so as to be adapted to be engaged by said at least one supporting member of the pipe alignment tool.

The adapter assembly provides a generally cylindrical surface which functions like the perimeter edge of a second pipe flange such that the pipe alignment tool that previously relied on the annular edge of the second pipe flange for engagement by the supporting members can now be used for use in alignment of a pipe flange with a mating annular surface locating circumferentially spaced apart threaded fasteners therein.

According to a first embodiment, the supporting surface is cylindrical so as to be arranged to extend about a full circumference of the plurality of threaded fasteners.

Preferably a radius of curvature of the supporting surface is approximately equal to a radius of curvature of the pipe flange.

In the first illustrated embodiment, the mounting body comprises a collar having an inner surface which is generally cylindrical. Preferably the inner diameter of the inner surface is approximately equal to a diameter of a circumcircle about the threaded fasteners.

The mounting body may comprise a plurality of clamping sections connected in series with one another to extend about a full circumference about the threaded fasteners. Preferably the plurality of clamping sections consists of two clamping sections, each extending about a respective portion of the circumference about the threaded fasteners. The two clamping sections may each extend circumferentially through an arc of approximately 180 degrees. Preferably the ends of the clamping sections are connected to one another by clamping fasteners which are adjustable in length in the circumferential direction so as to adjust an overall circumference of the mounting body.

When used in combination with the pipe alignment tool in which the supporting member of the pipe alignment tool further comprises a rotatable bearing member, preferably the supporting surface of the adapter assembly is adapted to receive the rotatable bearing member for rolling movement in the circumferential direction thereon.

The adapter assembly may further include an anti-rotation member supported on the mounting body and engaging the threaded posts so as to resist rotation of the mounting body relative to the mating annular surface about a central axis of the mating annular surface. Preferably the anti-rotation member comprises a protrusion supported on an inner surface of the mounting body to protrude inwardly from the mounting body so as to be arranged to be received between an adjacent pair of the threaded fasteners.

Alternatively, according to a second illustrated embodiment, the mounting body may be arranged to extend only partway about an outer circumference of a portion of the fasteners. In this instance, the assembly preferably further comprises at least one clamping member arranged to clamp the mounting body externally along said portion of the fasteners. Preferably a radius of curvature of the supporting surface is approximately equal to a radius of curvature of the pipe flange. Preferably the mounting body also comprises an inner surface shaped to form part of a cylinder, in which a radius of curvature of the inner surface is approximately equal to a radius of a circumcircle about the threaded fasteners.

According to a second aspect of the present invention there is provided a method of aligning a pipe flange having circumferentially spaced bolt apertures therein with a mating annular surface locating circumferentially spaced threaded fasteners therein, the method comprising:

providing a pipe alignment tool having a clamp member for extending circumferentially about the pipe flange and at least one supporting member mounted on the clamp member so as to extend longitudinally from a first end fixed to the clamp member to an opposing second end,

providing an adapter assembly having a mounting body locating a supporting surface externally thereon which forms at least a portion of a cylinder;

clamping the clamp member of the pipe alignment tool circumferentially about the pipe flange such that said at least one supporting member protrudes axially beyond the pipe flange towards the mating annular surface;

supporting the mounting body of the adapter assembly in a circumferential direction about at least some the threaded fasteners of the mating annular surface; and

engaging the supporting surface of the adapter assembly with said at least one supporting member of the pipe alignment tool such that the mating annular surface and the pipe flange can be axially displaced along a longitudinal axis relative to one another and pivoted relative to one another about said longitudinal axis so as to align the threaded fasteners of the mating annular surface with the bolt apertures in pipe flange.

Two embodiments of the invention will now be described in conjunction with the accompanying drawings in which:

### BRIEF DESCRIPTION OF THE DRAWINGS

FIG. 1 is a perspective view of the adapter assembly according to a first embodiment being used with a pipe alignment tool for connecting the pipe flanges of two mating components;

FIG. 2 is a side view of the adapter assembly according to the first embodiment of FIG. 1 in use with the pipe alignment tool according to FIG. 1;

FIG. 3 is an end elevational view of the pipe alignment tool generally along the line 3-3 in FIG. 2;

FIG. 4 is an end elevational view of the adapter assembly according to the first embodiment of FIG. 1 generally along the line 4-4 in FIG. 2;

FIG. 5 is a perspective end view of the adapter assembly according to the first embodiment of FIG. 1 shown disassembled;

FIG. 6 is a perspective view of an end portion of one of the clamping sections of the adapter assembly according to the first embodiment of FIG. 1;

FIG. 7 is a perspective view of an end portion of a different one of the clamping sections of the adapter assembly according to the first embodiment of FIG. 1;

FIG. 8 is a perspective view of an anti-rotation member on one of the clamping sections of the adapter assembly according to the first embodiment of FIG. 1;

FIG. 9 is a perspective view of a second embodiment of the adapter assembly for use with an alignment tool;

FIG. 10 is an end elevational view of the adapter assembly according to the second embodiment of FIG. 9 shown extending circumferentially partway about some of the fasteners of a surface to be mated to a pipe flange;

FIG. 11 is a side elevational view of the adapter assembly according to the second embodiment of FIG. 9 shown together with the pipe alignment tool;

FIG. 12 is a perspective view of an outer side of the adapter assembly according to the second embodiment of FIG. 9; and

FIG. 13 is a perspective view of an inner side of the adapter assembly according to the second embodiment of FIG. 9.

In the drawings like characters of reference indicate corresponding parts in the different figures.

### DETAILED DESCRIPTION

Referring to the accompanying figures, there is illustrated an adapter assembly generally indicated by reference numeral 8. The adapter assembly 8 is typically used with a pipe alignment tool 10 normally used for joining two pipe sections such that the ends are abutted in alignment with one another forming a seam between the abutted ends where the pipe sections. The pipe sections may be joined either by welding or by bolting together flanges at the ends of the pipe.

The adapter assembly 8 adapts the pipe alignment tool 10 such that the tool 10 can be used for aligning a pipe flange 12 having circumferentially spaced bolt apertures 13 therein of a first component with a mating annular surface 14 locating circumferentially spaced threaded fasteners 16 therein of a second component. The adapter 8 is secured relative to the mating annular surface so as to circumscribe the threaded fasteners 16 such that tool 10 can align the pipe flange 12 with the adapter assembly instead of with a second pipe flange. In the illustrated embodiment, both components defining the pipe flange 12 and the mating annular surface 14 comprise blow out preventers which locate the pipe flange 12 and the annular surface 14 at axially opposing ends thereof.

The tool 10 generally comprises a clamp member 18 which clamps onto the pipe flange 12 of the first component. The clamp member is a generally annular member which encircles a longitudinal axis so as to be adapted to be clamped circumferentially about the first pipe section in which the longitudinal axis of the clamp is aligned with the longitudinal direction of the pipe section.

More particularly, the clamp member 18 comprises two semi-circular portions 20, each extending near 180 degrees about the circumference of the pipe section. Opposing ends of each portion 20 include bolt flanges 22 projecting radially outward from the longitudinal axis with bolt apertures formed therein such that the bolt flanges of one portion 20 can be bolted to the corresponding flanges of the other portion to fully encircle the pipe section and clamp the pipe section therebetween. Due to the two portions each spanning less than 180 degrees, a gap remains between the opposing ends of the two portions so that tightening the bolts joining the bolt flanges causes the clamp member 18 to be clamped and frictionally retained relative to the pipe.

In the illustrated embodiments, one supporting member 24 is mounted on the clamp member 18 so as to be positioned adjacent the bottom of the pipe in use so that the second pipe section can rest on the supporting member to carry the weight of the second pipe section on the first pipe section during relative alignment. Typically a plurality of supporting members 24 are mounted at circumferentially spaced positions about the longitudinal axis of the clamp member so that the supporting members 24 collectively center the second pipe coaxially with the first pipe. More particularly, a set of four supporting members at evenly spaced positions in the longitudinal direction is particularly advantageous for optimally supporting the two pipe sections relative to one another.

Each supporting member 24 comprises a first portion 26 fixed to the clamp member and a second portion 28 which is adjustably coupled to the first portion and adapted to engage the second pipe in rolling contact therewith.

The first portion includes a base portion 30 secured to a respective portion 20 of the clamp member in fixed relation either by welding or by securing the base portion with bolts to studs welded on the clamp member. A leg 32 extends radially outward from the base portion in relation to the longitudinal axis of the clamp member. An arm 34 of the first portion is fixed to the leg 32 and extends axially in the longitudinal direction from a first end fixed to the leg at a location spaced radially outward from the base portion to an opposing second end adapted to project axially beyond the pipe flange 12 towards the mating surface 14 for overlapping and spanning across the seam between the abutted components to be mounted.

The second portion 28 is connected to the second end of the arm 34 of the first portion so as to extend radially inward towards an inner end 36 for supporting the second component. The second portion 28 generally comprises an elongate threaded rod which is threadably received through a threaded aperture or nut formed at the second end at the arm of the first portion. Accordingly rotating the rod about a respective radial axis of the clamp causes the second portion to be radially displaced and adjusted in radial position relative to the clamp member and the pipe section upon which it is secured.

A bearing member may be mounted at the inner end of the second portion in the form of a freely rolling ball received within a socket (not shown) formed in the inner end of the second portion of the supporting member. A cap member (not shown) is threaded onto the inner end of the second portion overtop of the ball defining the bearing member so as to retain the bearing member within the socket. A central opening in the cap member allows the bearing member to protrude outwardly beyond the cap for rolling contact with the second pipe with which it engages.

The bearing is supported for free rotation in the any direction including rolling movement about an axis parallel to the longitudinal axis when rotating the second pipe about its longitudinal axis as well as rolling movement about an axis perpendicular to the longitudinal direction when axially displacing the second pipe towards and away from the first pipe.

The socket is suitably sized to allow some radial displacement of the bearing member within the socket relative to the first and second portions of the supporting member. A spring (not shown) may be mounted within the socket between the bearing member and the internal end of the socket so as to urge the bearing member in the radial direction relative to the second portion 28 towards the central longitudinal axis about which the clamp is aligned.

A grease port (not shown) may be formed to extend in a radial direction through the second portion 28 of the supporting member for communication at an inner end with the bearing member in the socket 40 and for communication at an outer end with a nipple formed on the outer end of the second portion. The nipple includes an injection port therethrough permitting attachment of a suitable grease gun or the like to inject grease through the grease port to maintain the bearing member well lubricated relative to the socket.

The clamp member 18 includes a plurality of designated mounting locations 50 formed thereon at circumferentially spaced apart positions in which each supporting member is arranged to be selectively supported at any one of the designated mounting locations so as to be readily separable from the clamp member. The designated mounting locations 50 comprise respective threaded bores formed in the collar of the clamp member about respective radially oriented axis at evenly spaced apart positions, for example at 1.5 inch intervals in the circumferential direction.

Position of each supporting members is thus readily adjustable in the circumferential direction. This is desirable for example to position the supporting members out of the way of obstructions that would prevent stud and bearing from contacting the other surface. Another advantage to adjustable placement of the supporting members is when a gasket needs to be installed between the flanges. Because of the circular gasket design for flanges, there is a certain amount of spacing required in order for the gasket to fit between the studs and bearings. More typically a user would place four supporting members equally spaced around the collar of the clamping member to maximize the alignment of the circular surfaces relative to one another.

Each supporting member in this instance includes a main body defining the leg 32 and the arm 34 noted above. A bore extends fully through the main body in a radial direction relative to the clamp member and pipe sections in alignment with the leg 32 to receive a threaded bolt 56 extending fully therethrough. A head of the bolt 56 is arranged to abut an outer side of the body 52 while the opposing threaded end of the bolt 56 protrudes radially inwardly beyond an engaging surface about the bore the inner side of the body 52 which defines the base 30 in abutment with the corresponding outer surface of the clamp member in a mounted position. The threaded end of the bolt is thus arranged to be received in threaded connection into a selected one of the threaded bores in the clamp member when the body is abutted with the outer side of the clamping member. The bolt has a suitable length such that the threaded end protrudes from the body by a radial distance which is less than a radial thickness of the body of the clamping member, which may be ⅝ of an inch for example, such that the bolts do not engage through the clamp member into the pipe sections.

The bore receiving the bolt 56 therein is sufficient oversized relative to the bolt that the bolt is freely rotatable within the bore. The inner end of the bore includes a recessed counter bore of increased diameter to accommodate a snap ring (not shown) in a corresponding groove about the bolt. The groove in the bolt is located relative to the bolt head so as to be received within the counter bore when the bolt head is abutted with the outer side of the body. The snap ring serves to retain the bolt rotatable within the bore by abutment with an inner end face of the counter bore even when the bolt is threadably released from a corresponding bore in the clamp member such that the bolt remains readily accessible for reattachment to the clamp member at a different mounting location.

The inner end of the leg portion 32 of the body is stepped to define the engaging surface of the base 30 which is recessed radially into the body relative to a remaining end face of the main body.

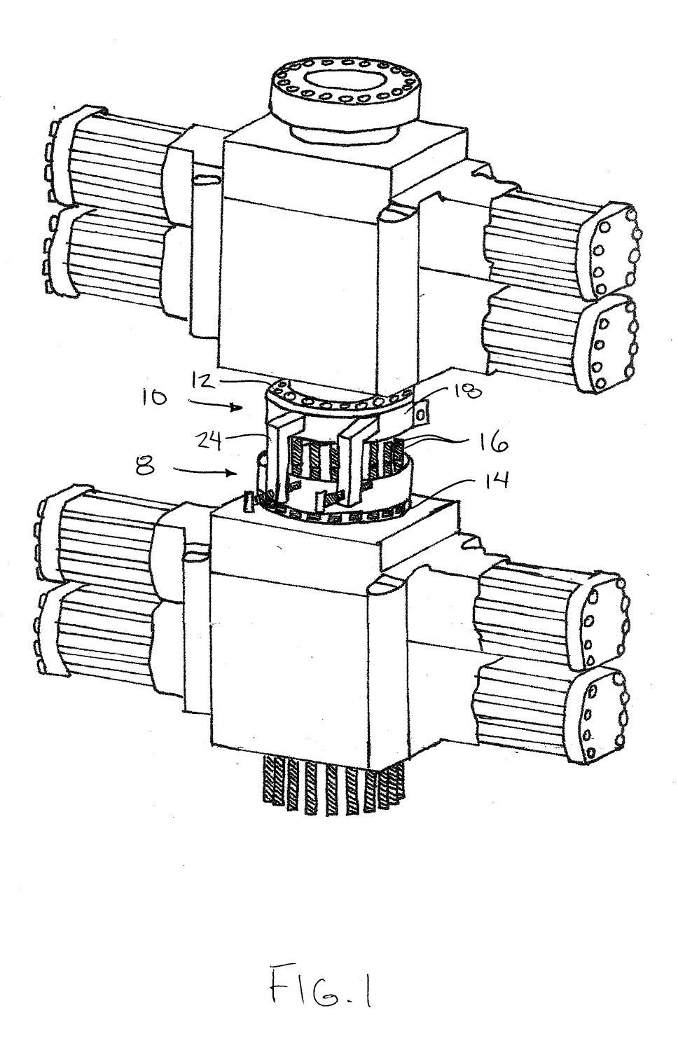

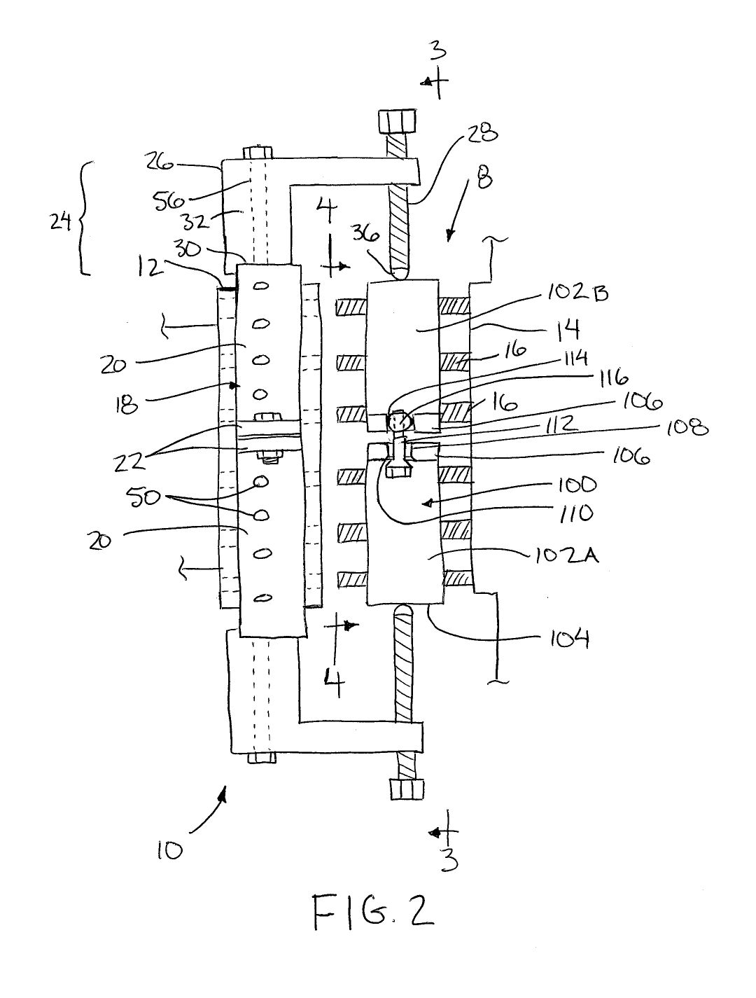

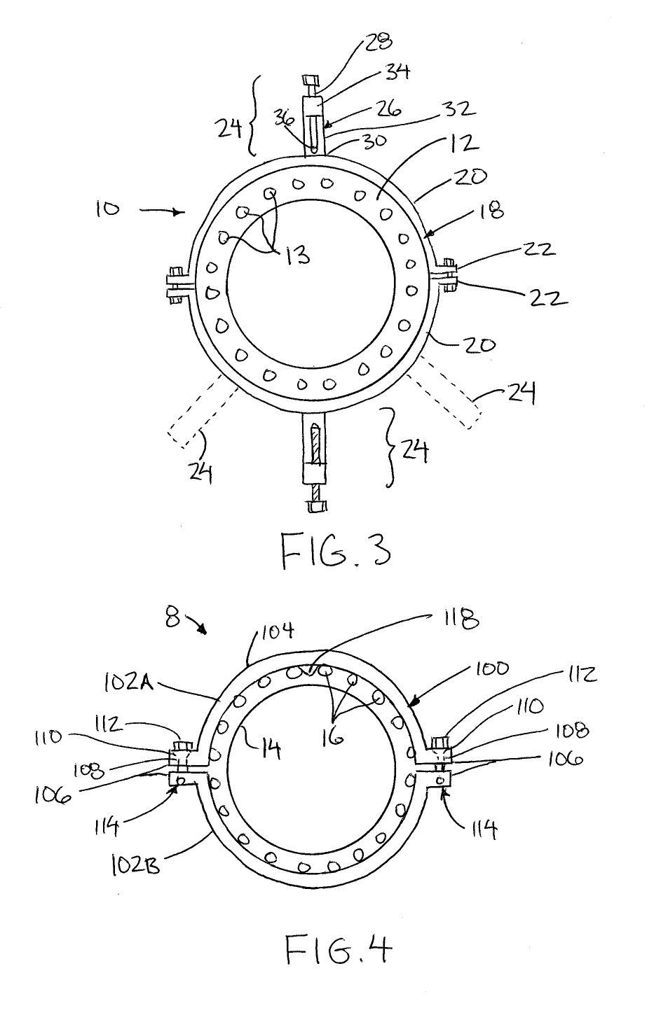

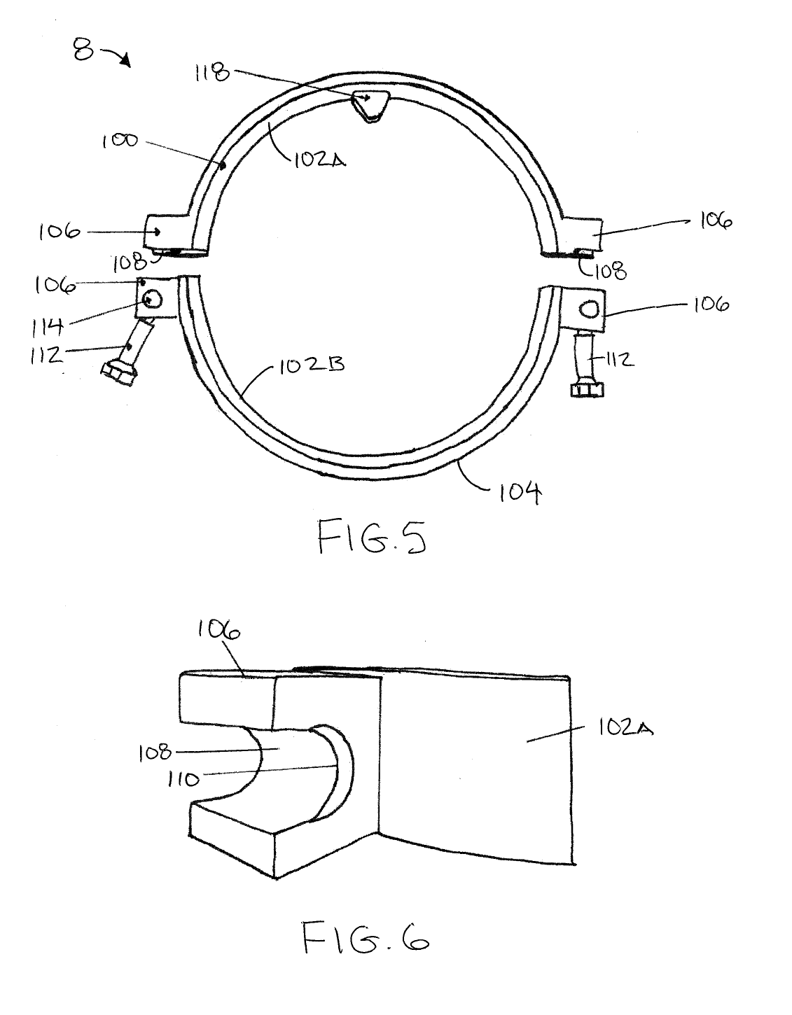

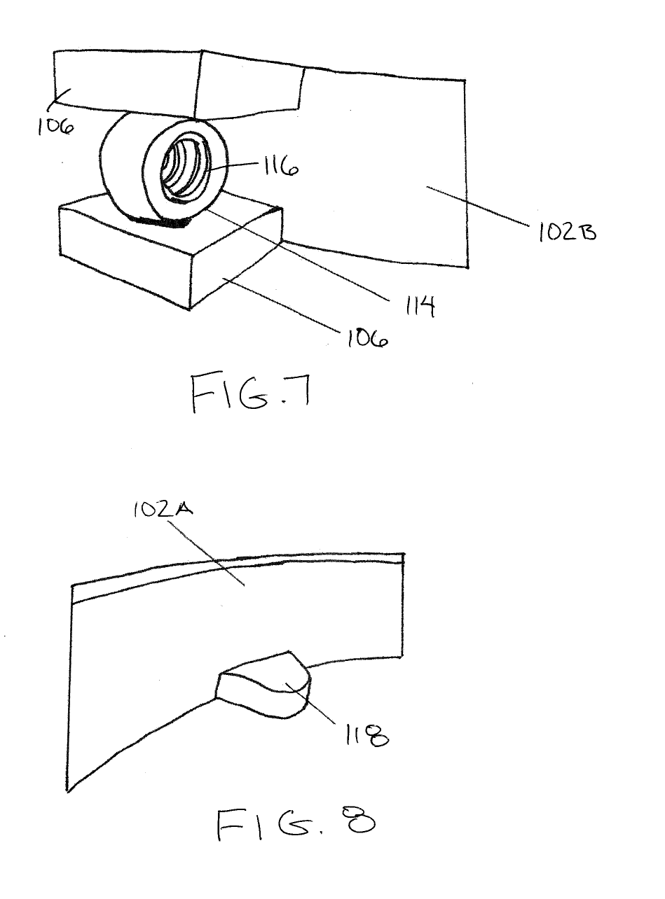

Turning now to features of the adapter 8 according to the first embodiment of FIGS. 1 through 8, the adapter includes a mounting body 100 in the form of a collar which circumscribes the threaded fasteners 16 of the annular surface 14. The mounting body 100 is formed in two clamping sections 102 which each extend circumferentially through an arc of approximately 180° between opposing ends thereof. The opposing ends are connected in series such that the two clamping sections extend about the full circumference of the circumferentially spaced apart fasteners 16.

When assembled, the two sections 102 collectively define an outer supporting surface 104 in which each clamping section defines a portion of the surface of a cylinder. The resulting cylindrical supporting surface 104 has an outer diameter which is approximately equal to an outer diameter of the pipe flange 12. The inner diameter of the collar formed by the assembled clamping sections 102 is approximately equal to the diameter of a circle circumscribing all of the plurality of fasteners 16.

Each section 102 includes a pair of mounting blocks 106 formed at the circumferentially opposing ends thereof. The mounting blocks protrude radially outwardly relative to the outer supporting surface 104. The two mounting blocks 106 at the ends of a first clamping section 102A include respective slots formed therein which extend fully through the block in the circumferential direction and which are opened to the exterior in the radial direction. An inner end of each of the slots 108 includes a counterbore 110 formed in the end face of the mounting block 106 such that the counterbore receives the head of a clamping fastener 112 therein when the threaded shaft of the clamping fastener extends circumferentially through the slot 108 towards the opposing second clamping section 102B. The counterbore is generally frusto-conical in shape to mate with a corresponding frusto-conical shape of the inner face of a respective one of the clamping fasteners 112 for mating coaxial alignment with one another.

Each mounting block 106 of the second section 102B locates a respective socket 114 therein having an internally threaded bore 116 which receives the threaded shaft of a respective one of the clamping fasteners 112. Each socket 114 comprises a respective socket body which is pivotally mounted relative to the mounting block 106 receiving the socket body therein such that the orientation of the bore 116 can be pivoted about an axis which is parallel to a central axis of the cylindrical shape of the assembled mounting body. The bore 116 of each socket body is perpendicular to the pivot axis thereof.

In the assembled configuration, the two clamping sections 102 are assembled in series with one another in the circumferential direction, with the opposing ends remaining slightly spaced apart from one another. The clamping fasteners are positioned such that the end of the threaded shaft is threaded into a respective bore of one of the two socket bodies at opposing ends of the second section 1028 while the remainder of the shaft spans between the corresponding ends of the first and second clamping sections to extend through the slot 108 of the respective first section so that the head of the clamping fastener 112 is received within the counterbore 110 at the inner side of the corresponding mounting block. Threadably adjusting the clamping fasteners serves to adjust the length of each clamping fastener spanning between the two adjacent clamping sections of the mounting body so as to adjust the overall circumference of the mounting body circumscribing the fasteners 16 by adjusting the length of each individual clamping fastener in the circumferential direction.

An anti-rotation member 118 is supported on the interior surface of the first section 102A to protrude radially inward therefrom. The anti-rotation member is suitably sized to snugly fit between two adjacent ones of the fasteners 16 in the mounting position of the adapter. In this manner, the engagement of the anti-rotation member 118 between the fasteners 116 serves to prevent rotation of the assembled mounting body 100 relative to the annular surface 14 in the circumferential direction about a central axis of the cylindrical shape of the mounting body and a central axis of the annular surface 14.

In use, when joining two components in which a pipelines with circumferentially spaced apart bolt apertures must be aligned with a corresponding mating surface 14 having circumferentially spaced apart threaded fasteners 16 mounted therein, the adapter assembly 8 is mounted such that the mounting body 110 circumscribes the fasteners with the cylindrical outer supporting surface 104 thereof being concentric with a central axis of the annular surface 14. The alignment tool 10 is then mounted circumferentially about the pipe flange 12 with the support members thereof protruding axially towards the mating annular surface 14 such that the bearings at the inner ends 36 of the pipe supporting members are suited for rolling engagement with the outer supporting surface 104.

A plurality of circumferentially spaced apart support members 24 assists in locating the pipe flange 12 concentrically with the annular surface 14. Rotation about a central longitudinal axis of the pipe flange 12 and the annular surface 14 permits the fasteners 16 to be aligned with corresponding ones of the bolt apertures 13 in the pipe flange. Further rolling of the bearing members at the inner ends 36 of the pipe support members 24 in the axial direction relative to the outer supporting surface 104 permits the fasteners 16 to be subsequently inserted into respective ones of the holes 13. Initially the fasteners are only partially inserted into respective bolt holes in the pipe flange. At this point the adapter assembly 8 can be removed. Optionally the pipe alignment tool can also be removed. The partial insertion of the threaded fasteners 16 into the bolt apertures 13 serves to retain alignment of the pipe flange 12 with the mating annular surface 14 until the two components are subsequently fully abutted. Nuts are threaded onto the ends of the fasteners 16 to assist in pulling the two components together and to retain the two components clamped together.

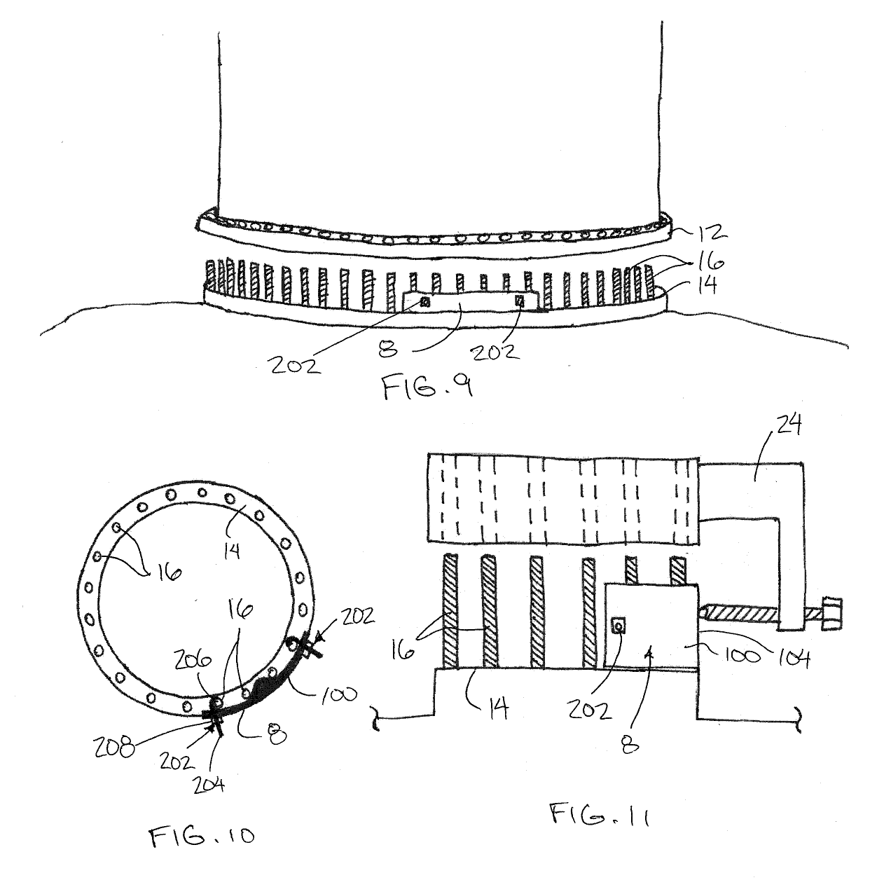

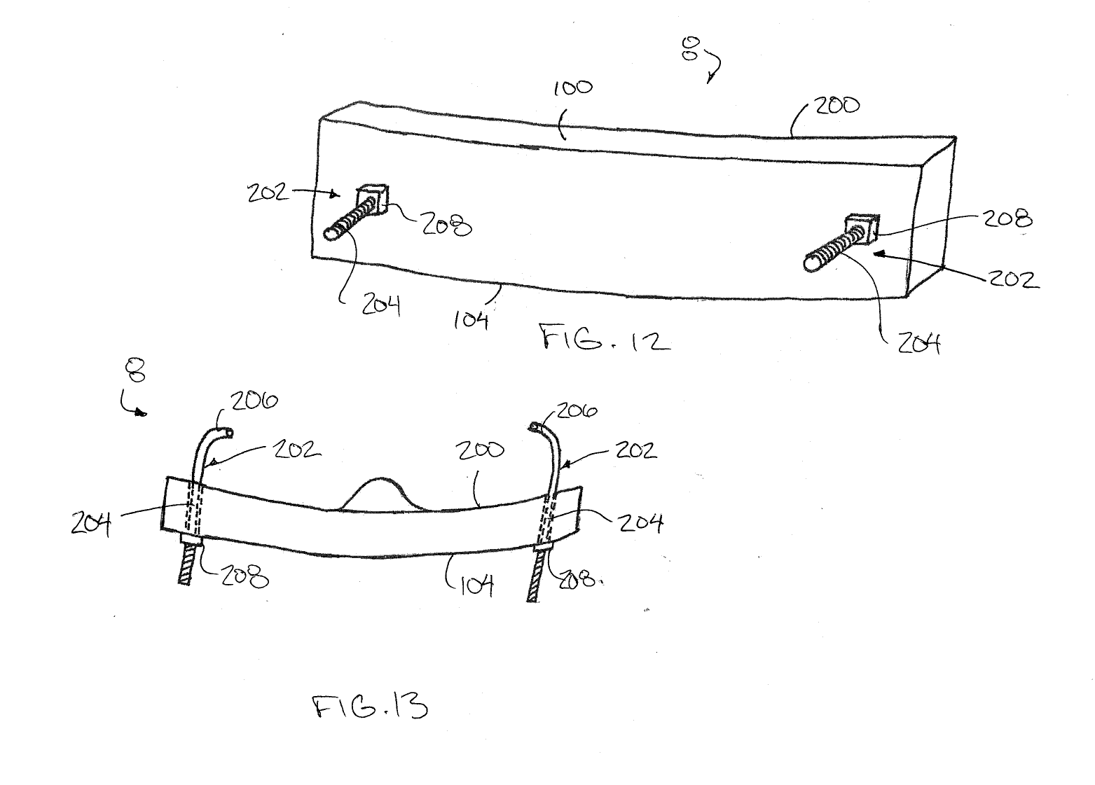

Turning now to features of the adapter 8 according to the second embodiment of FIGS. 9 through 13, the adapter 8 again comprises a mounting body 100 which is mounted to extend in a circumferential direction about some of the threaded fasteners of the mating annular surface; however, the mounting body in this instance only extends partway about the outer circumference along a path corresponding to a circumcircle about the threaded fasteners collectively.

The mounting body 100 thus follows an arc shaped path having an inner surface 200 forming part of a surface of a cylinder and having a radius of curvature which is approximately equal to a radius of a circumcircle about the threaded fasteners collectively. The mounting body 100 also includes a corresponding outer surface which defines the supporting surface 104 which also forms a portion of a cylinder having a radius of curvature which is approximately equal to radius of curvature of the pipe flange.

To retain the mounting body secured along the outer side of the threaded fasteners with which it is associated, the mounting body is provided with two clamping fasteners 202 for clamping the mounting body against the outer side of two selected ones of the fasteners 16. Each clamping fastener includes a main portion 204 which is linear and which extends generally radially through a corresponding mounting aperture in the mounting body, in which the mounting apertures are spaced apart from one another in the circumferential direction towards opposing ends of the mounting body. An innermost end 206 of each clamping fastener is hook shaped for being hooked about the inner side of the respective fasteners 16 with which the clamping fastener is associated. A nut 208 is threaded onto the main portion 204 at a location where the main portion protrudes radially outward beyond the outer side of the mounting body.

In order to secure the mounting body to the fasteners 16 of the mating surface 14, the nuts 208 are loosened to allow the inner ends 206 of the two clamping fasteners 202 to be hooked about the inner side of two selected fasteners 16 while the mounting body is abutted against the outer sides of the corresponding fasteners 16. Tightening the nuts 208 effectively clamps the mounting body against the outer side of the corresponding fasteners 16 such that the mounting body extends in the circumferential direction about a portion of the fasteners along a path which circumscribes the fasteners 16 collectively.

The adapter 8 according to the second embodiment similarly includes an anti-rotation member 118 protruding from the inner surface 200 thereof for being snugly received between an adjacent pair of fasteners 16 similarly to the previous embodiment.

The adapter 8 according to the second embodiment is used in cooperation with the pipe alignment tool 10 as described above with regard to the first embodiment by locating the supporting members 24 such that the inner ends 36 are mounted in sliding or rotatable contact with the outer supporting surface 104 to enable relative rotation about a central axis of the components being mated as well as to allow some relative axial movement.

Since various modifications can be made in my invention as herein above described, it is intended that all matter contained in the accompanying specification shall be interpreted as illustrative only and not in a limiting sense.

1. An adapter assembly for use with a pipe alignment tool for aligning a pipe flange having circumferentially spaced bolt apertures therein with a mating annular surface locating circumferentially spaced threaded fasteners therein, the pipe alignment tool having a clamp member adapted to be clamped about the pipe flange and at least one supporting member mounted on the clamp member so as to extend longitudinally from a first end fixed to the clamp member to an opposing second end protruding axially beyond the pipe flange, the adapter assembly comprising:
a mounting body arranged to be mounted to extend in a circumferential direction about at least some of the threaded fasteners of the mating annular surface; and
a supporting surface located externally on the mounting body forming at least a portion of a cylinder so as to be adapted to be engaged by said at least one supporting member of the pipe alignment tool.

2. The assembly according to claim 1 wherein the supporting surface is cylindrical so as to be arranged to extend about a full circumference of the plurality of threaded fasteners.

3. The assembly according to claim 1 wherein a radius of curvature of the supporting surface is approximately equal to a radius of curvature of the pipe flange.

4. The assembly according to claim 1 wherein the mounting body comprises a collar having an inner surface which is generally cylindrical.

5. The assembly according to claim 4 wherein an inner diameter of the inner surface is approximately equal to a diameter of a circumcircle about the threaded fasteners.

6. The assembly according to claim 1 wherein the mounting body comprises a plurality of clamping sections connected in series with one another to extend about a full circumference about the threaded fasteners.

7. The assembly according to claim 6 wherein the plurality of clamping sections consists of two clamping sections, each extending about a respective portion of the circumference about the threaded fasteners.

8. The assembly according to claim 7 wherein the two clamping sections each extend circumferentially through an arc of approximately 180 degrees.

9. The assembly according to claim 6 wherein ends of the clamping sections are connected to one another by clamping fasteners which are adjustable in length in the circumferential direction.

10. The assembly according to claim 1 in combination with the pipe alignment tool in which said at least one supporting member of the pipe alignment tool further comprises a rotatable bearing member and wherein the supporting surface of the adapter assembly is adapted to receive the rotatable bearing member for rolling movement in the circumferential direction thereon.

11. The assembly according to claim 1 further comprising an anti-rotation member supported on the mounting body and engaging the threaded posts so as to resist rotation of the mounting body relative to the mating annular surface about a central axis of the mating annular surface.

12. The assembly according to claim 11 wherein the anti-rotation member comprises a protrusion supported on an inner surface of the mounting body to protrude inwardly from the mounting body so as to be arranged to be received between an adjacent pair of the threaded fasteners.

13. The assembly according to claim 1 wherein the mounting body is arranged to extend only partway about an outer circumference of a portion of the fasteners and wherein the assembly further comprises at least one clamping member arranged to clamp the mounting body externally along said portion of the fasteners.

14. The assembly according to claim 13 wherein a radius of curvature of the supporting surface is approximately equal to a radius of curvature of the pipe flange.

15. The assembly according to claim 13 wherein the mounting body comprises an inner surface shaped to form part of a cylinder, wherein a radius of curvature of the inner surface is approximately equal to a radius of a circumcircle about the threaded fasteners.

16. A method of aligning a pipe flange having circumferentially spaced bolt apertures therein with a mating annular surface locating circumferentially spaced threaded fasteners therein, the method comprising:
providing a pipe alignment tool having a clamp member for extending circumferentially about the pipe flange and at least one supporting member mounted on the clamp member so as to extend longitudinally from a first end fixed to the clamp member to an opposing second end,
providing an adapter assembly having a mounting body locating a supporting surface externally thereon which forms at least a portion of a cylinder;
clamping the clamp member of the pipe alignment tool circumferentially about the pipe flange such that said at least one supporting member protrudes axially beyond the pipe flange towards the mating annular surface;
supporting the mounting body of the adapter assembly in a circumferential direction about at least some of the threaded fasteners of the mating annular surface; and
engaging the supporting surface of the adapter assembly with said at least one supporting member of the pipe alignment tool such that the mating annular surface and the pipe flange can be axially displaced along a longitudinal axis relative to one another and pivoted relative to one another about said longitudinal axis so as to align the threaded fasteners of the mating annular surface with the bolt apertures in pipe flange.
